(19) United States
(12) Patent Application Publication
(10) Pub. No.: US 2008/0236552 A1
(43) Pub. Date: Oct. 2, 2008

(54) Mixture Device for Gaseous Fuel and Air

(75) Inventor: Takashi Horikawa, Natori-City (JP)

Correspondence Address: REISING, ETHINGTON, BARNES, KISSELLE, P.C., P O BOX 4390, TROY, MI, 48099-4390, US

(73) Assignee: Walbro Engine Management, L.L.C., Tucson, AZ (US)

(21) Appl. No.: 12/055,846

(22) Filed: Mar. 26, 2008

(30) Foreign Application Priority Data
Apr. 2, 2007 (JP) 2007096718

(51) Int. Cl. F02B 43/00

(52) U.S. Cl. 123/527; 123/590

(57) ABSTRACT

A fuel mixing device includes a body having an intake bore, a first surface, and a second surface adjacent to the first surface. A first valve device may be carried by the body on the first surface and a second valve device may be carried by the body on the second surface. A first fuel passage may be provided in the body communicating with the first valve device and adapted to communicate with a supply of fuel. A second fuel passage communicates with the second valve device and the first fuel passage to permit fuel that has passed through the first valve device to flow to the second valve device, wherein the first fuel passage and the second fuel passage connect to at least one of the first surface or the second surface.

### REFERENCE TO RELATED APPLICATION

This application claims the benefit of and priority from Japanese Patent Application Ser. No. 2007-096718, filed Apr. 2, 2007.

### FIELD OF THE INVENTION

The present invention relates generally to a fuel system component, and more particularly to a mixing device for gaseous fuel and air.

### BACKGROUND OF THE INVENTION

Internal combustion engines are capable of running on multiple types of gaseous fuels such as propane and butane. Providing a gaseous fuel mixed with air to the engine entails the use of valves, regulators and mixers to control the amount of fuel and pressure at which the fuel is delivered. Accordingly, conventional gas pressure regulators are configured to open a fuel passage during the operation of the engine, and shut-off valves also are used to regulate fuel flow. A shut-off valve is used in conjunction with and located separately from a gas-air mixing device that attaches to the engine intake bore and provides a gaseous fuel and air mixture to the engine. A pressure regulator may be provided on the mixing device downstream of the remotely located shut-off valve to control the pressure of fuel delivered to a fuel passage of the mixing device. But the location and number of regulators, shut-off valves and mixing devices results in a fuel delivery system that is unnecessarily bulky and complex, and difficult to adjust for at least the reason that the various components are remotely located or not easily accessible.

### SUMMARY OF THE INVENTION

A fuel mixing device includes a body having an intake bore, a first surface, and a second surface adjacent to the first surface. A first valve device may be carried by the body on the first surface and a second valve device may be carried by the body on the second surface. A first fuel passage may be provided in the body communicating with the first valve device and adapted to communicate with a supply of fuel. A second fuel passage communicates with the second valve device and the first fuel passage to permit fuel that has passed through the first valve device to flow to the second valve device, wherein the first fuel passage and the second fuel passage connect to at least one of the first surface or the second surface.

In another implementation, a fuel mixing device includes a body having an intake bore, a first surface, and a second surface. A first valve device may be formed as a separate assembly from the body and mounted on the first surface, the first valve device may include a valve and be constructed so that the valve is open when an engine associated with the mixing device is operating and closed when the engine is not operating. A second valve device may be formed as a separate assembly from the body, and mounted on the second surface. A first fuel passage is formed within the body for carrying fuel between a fuel source and the first valve device and a second fuel passage is formed within the body for carrying fuel between the first valve device and the second valve device. At least one control mechanism may be provided to adjust fuel flow into the intake bore, and the control mechanism may be carried by the body and associated with at least one of the first valve device or the second valve device. The first valve device permits fuel flow to the second valve device when the engine is operating and the second valve device is constructed to regulate the pressure of fuel delivered to the intake bore. Thus, a body with an intake bore through which fuel is delivered to an engine, a pressure regulating valve and a valve that prevents fuel flow to the pressure regulating valve unless the engine is operating are provided in one integral device. This device may be made generally compact, and may provide internal fluid passages that permit the valve devices to be formed as separate assemblies from the body and attached thereto for ease of assembly of the mixing device and use of different valves with the same body design to provide different operating characteristics, as desired.

### BRIEF DESCRIPTION OF THE DRAWINGS

The following detailed description of exemplary embodiments of the invention will best be understood with reference to the accompanying drawings, in which:

FIG. 1 is a front view of a gaseous fuel and air mixing device;

FIG. 2 is plan view of the device;

FIG. 3 is a sectional view taken along line III-III of FIG. 1;

FIG. 4 is a sectional view taken along line IV-IV of FIG. 1;

FIG. 5 is sectional view taken along line V-V of FIG. 2;

FIG. 6 is a sectional view taken along line VI-VI of FIG. 2;

FIG. 7 is a sectional view taken along line VII-VII of FIG. 2;

FIG. 8 is a perspective view of the device; and

FIG. 9 is a side view of the device.

### DETAILED DESCRIPTION OF PREFERRED EMBODIMENTS

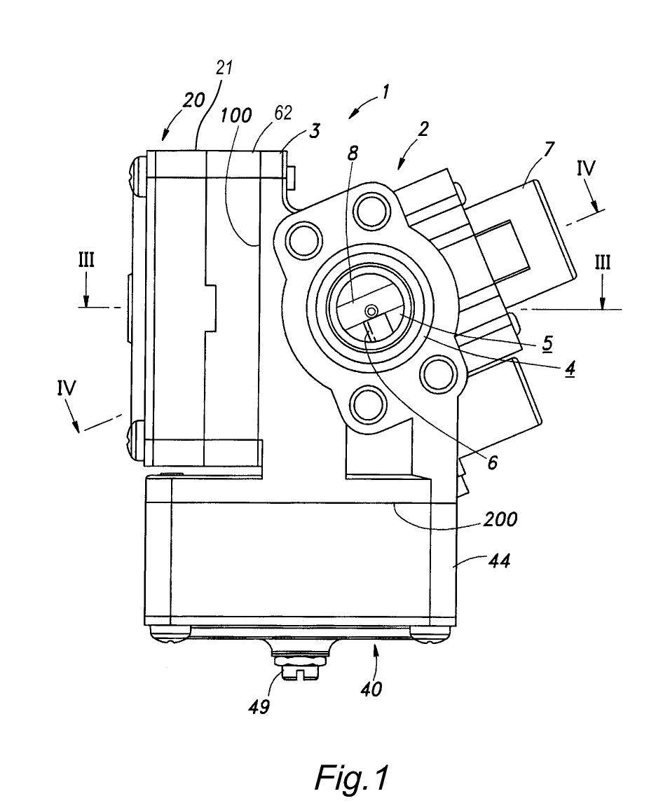

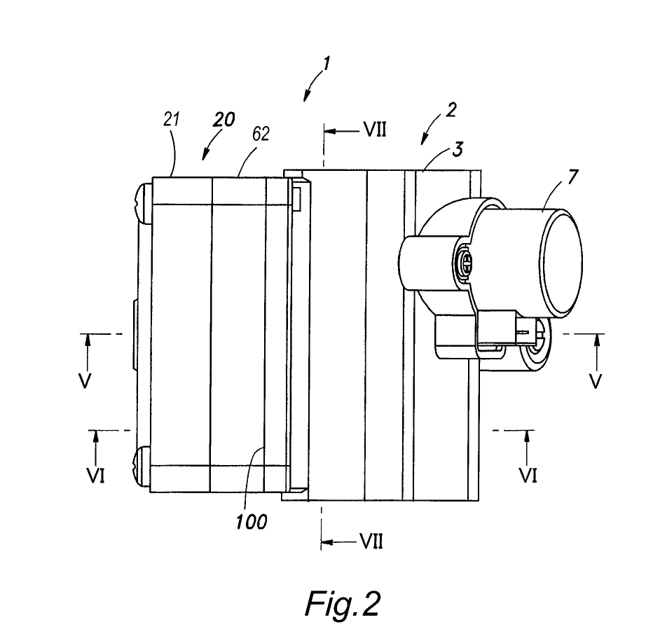

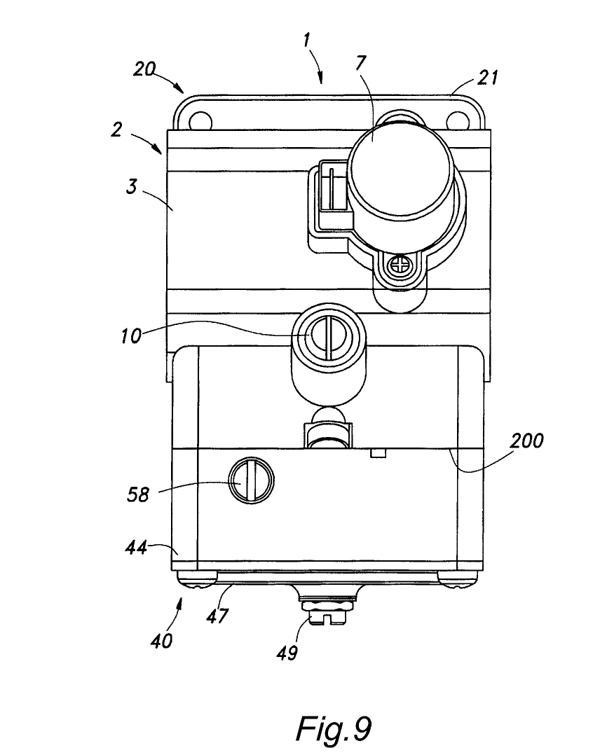

Referring in more detail to the drawings, FIGS. 1 and 2 illustrate a gas-air mixing device 1 integrally incorporating a main body 2, a first valve device 20 carried by a first side surface 100 of the main body 2 and a second valve device 40 carried by a second side surface 200 of the main body that is adjacent to the first side surface 100. Additionally, the first side surface 100 and the second side surface 200 can be substantially parallel to an axial line of an intake bore 4. The fuel-air mixing device 1 provides fuel to an engine and uses control mechanisms 10 or adjustment knobs 58 that control fuel flow rate. The control mechanism 10 and the adjustment knobs 58 can be located generally on one side of the device 1 opposite either the first valve device 20 or the second valve device 40, as best shown in FIG. 9. The control mechanisms 10 or adjustment knobs 58 can be positioned substantially perpendicular to the intake bore 4 and/or located opposite either the first valve device 20 or the second valve device 40.

The first valve device 20 and the second valve device 40, as well as the first side surface 100 and the second side surface 200, can be positioned substantially perpendicular to each other. The arrangement of the first valve device 20, second valve device 40, control mechanisms 10, and adjustment knobs 58 can facilitate the adjustment of the device 1 from one side of the device. As a result, the device 1 may be mounted in a wide variety of positions and remain easily adjustable, and access openings or paths conveniently can be located together or along the same side of the device. Furthermore, first valve device 20 and second valve device 40 can be formed as separate assemblies. As separate assemblies, a variety of devices 20 and 40 can be produced, each suited for a particular engine application. But while the devices 20 and 40 can be different, the devices 20 and 40 can be designed for use with a universal main body 2, thereby reducing costs.

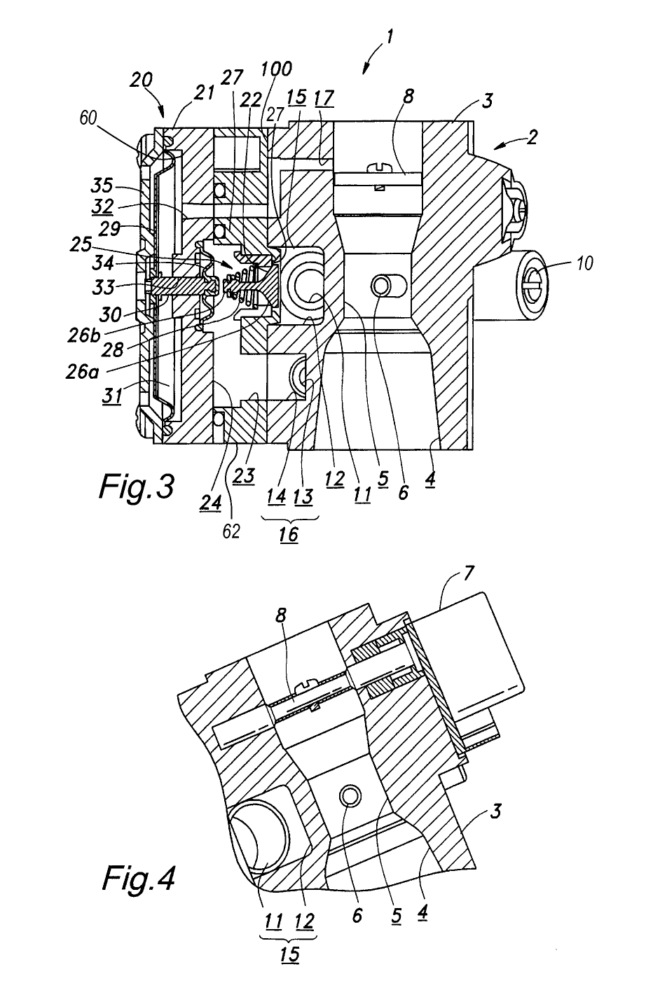

As shown in FIGS. 3 and 4, the intake bore 4 includes a venturi 5 which includes a nozzle 6 through which fuel is delivered into the bore 4. The intake bore 4 includes a throttle valve 8 downstream of the venturi 5 that is movable to control the fuel flow in and through the intake bore 4. The throttle valve 8 may include a butterfly valve that can be rotated by a stepper motor 7 about an axial line of the motor 7. An intermediate plate 62 of the first valve device 20 may include a first valve device inlet port 22 that controls the inflow of fuel into the first valve device 20 and a first valve device outlet port 23 through which fuel flows when the first valve 25 is open. The first valve device inlet port 22 may communicate with a first fuel passage 15, and the first valve device outlet port 23 may communicate with a second fuel passage 16. In one implementation, the first fuel passage 15 and second fuel passage 16 are cast in the casing 3 and the size of the device 1 can be reduced. Additionally, an intermediate passage 24 may communicate the inlet port 22 and outlet port 23 with each other. The inlet port 22 can include a first valve 25, which may use a valve member. The valve member may include a conically shaped valve head 26a, a coaxially formed stem 26b that can be rod-shaped and extend from the valve head, a first valve seat 27, and a biasing member such as a spring 28. The valve member can be carried by the intermediate plate 62. The spring 28 can be disposed or engaged between the stem 26b and the valve seat 27 in such a manner that the valve head 26a may be resiliently urged against the valve seat 27 and normally close it. When the valve head 26a is removed from the valve seat 27, fuel flows through the first valve 25 and to the second fuel passage 16.

The outer plate 21 can include a first diaphragm 29 and a recessed side surface 60 facing away from the main body 2. The first diaphragm 29 may be substantially circular in shape and use a rod 30 centrally positioned and in a coaxial relationship to the stem 26b of the valve member, and arranged to selectively engage the stem 26b of the valve member. The outer periphery of the first diaphragm 29 may be interposed between the outer plate 21 and a first lid 35. The first lid 35 can be provided with a plurality of openings so that the space between the first lid 35 and first diaphragm 29 is maintained at atmospheric pressure. The side surface 60 of the outer plate 21 may be recessed so that a first negative pressure chamber 31 is formed between the side surface 60 and the first diaphragm 29. The side surface 60 may be provided with a negative pressure induction passage 32 and a rod hole 33 disposed coaxially with the stem 26b of the valve member for slidably receiving the rod 30.

To provide a negative pressure signal to the pressure chamber 31, the induction passage 32 may communicate with a main body negative pressure passage 17 that, in turn, communicates with the intake bore 4 at a point downstream of the throttle valve 8. The rod 30 may be passed through the rod hole 33 and have a free end that extends into the first valve device passage 24. The free end of the rod 30 can be attached to a diaphragm seal 34 so that the gas in the first negative pressure chamber 31 does not mix with the gas in the intermediate passage 24. The diaphragm seal 34 is flexible and permits movement of the rod 30 relative to the stem 26b.

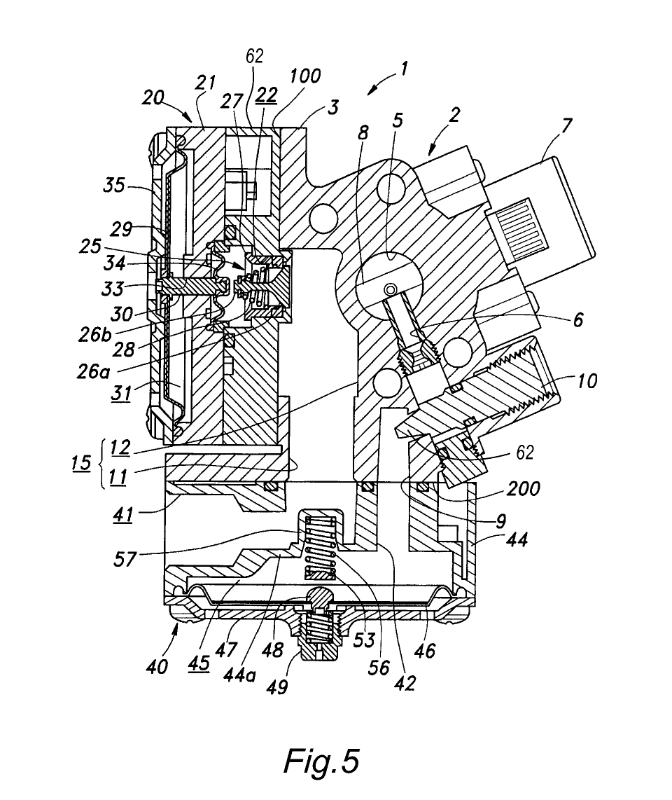

As shown in FIG. 5, the main body 2 includes the fuel nozzle 6 and a fuel ejection passage 9 that communicate with a second valve device outlet port 42 from which fuel exits the second valve device 40. The fuel ejection passage 9 may include a control mechanism 10 formed by a needle valve 61 that adjusts the amount of fuel that flows to the nozzle 6. The main body 2 also can include a first conduit 11 formed in a bottom end of the main body 2 that communicates with a fuel injection port 41 and a first groove passage 12 formed in the side surface of the main body 2. The first groove passage 12 can operate as an open channel for communication with the first conduit 11. The first groove passage 12 defines a passage with the side surface of the intermediate plate 62 of the first valve device 20 when the first valve device 20 attaches to the main body casing 3. Together, the conduit 11 and passage 12 may define the first fuel passage 15.

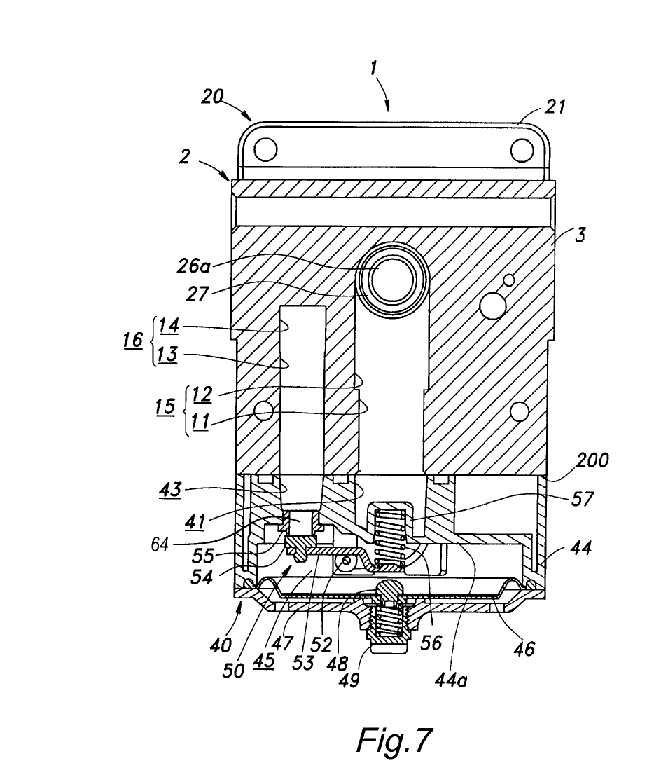

As best shown in FIGS. 5 and 7, the fuel injection port 41 is formed in the second valve device 40 which may communicate with a fuel source (not shown). As shown in FIGS. 5, 6, and 7, the second valve device 40 may be provided with a fuel pressure regulating chamber 45 that is separated from the fuel injection port 41 and forms a part of the first fuel passage 15 with a partition wall 44(a) of a second valve device casing 44. The partition wall 44(a) can separate the chamber 45 from the first fuel passage 15 as can be appreciated in FIG. 5. The second valve device casing 44 can use a second diaphragm 46 on a side facing away from the partition wall 44a. The second diaphragm 46 may have a substantially circular shape with the peripheral part interposed between a second lid 47 defining a side surface of the second valve device 40 and the second valve device casing 44. A projection 48 may be carried by the central part of the second diaphragm 46. The second lid 47 may utilize a plurality of openings so that the space between the second lid 47 and the second diaphragm 46 can be maintained at atmospheric pressure. The central part of the second lid 47 may be provided with a fuel pressure regulating mechanism 49 that can include a spring that resiliently urges the second diaphragm 46 and thereby regulates the fuel pressure. An adjustment screw permits adjustment of the compression and hence, initial force provided by the spring.

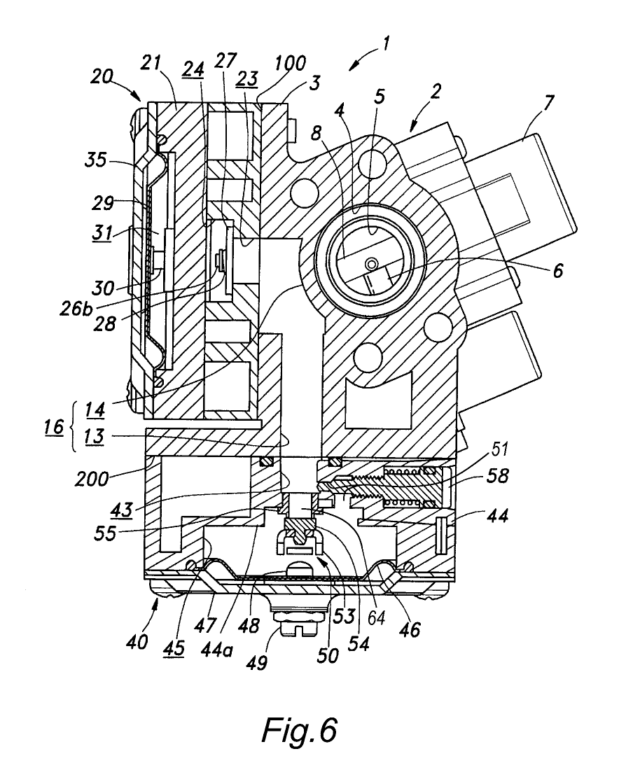

As shown in FIGS. 6 and 7, the fuel pressure regulating chamber 45 may communicate with a second valve device inlet port 43 and the second valve device outlet port 42. A fuel pressure regulating valve 50 and a bypass passage 51 may also be included between the fuel pressure regulating chamber 45 and the second valve device inlet port 43, as is best shown in FIG. 6. The fuel pressure regulating valve 50 may include a fuel pressure regulating lever 53 pivotally supported by a support shaft 52 secured to the second valve device casing 44. A spring 56 having an end engaging the fuel pressure regulating lever 53 may resiliently urge the fuel pressure regulating lever 53 in a valve closing direction. The other end of the pressure regulating spring 56 may be received in a spring seat 57. The spring seat 57 can be formed in or as a recessed part of the partition wall 44a facing toward the regulating chamber 45. Because the spring seat 57 is recessed, the volume occupied by the regulating chamber 45 can be reduced a corresponding amount contributing to the compact design of the second valve device 40.

The valve 50 may also include a valve head or member 54 secured to an end of the lever 53 and configured to selectively permit the flow of fuel from the inlet port 43 to the fuel pressure regulating chamber 45. A second valve seat 55 may define an opening or passage 64 that forms at least part of the inlet port 43 through which fuel flows when the valve 50 is open to provide fuel to the intake bore 4. The bypass passage 51 may be provided with a bypass flow rate control mechanism 58 consisting of a needle valve 61 for adjusting the flow rate of the fuel that flows through the bypass passage 51.

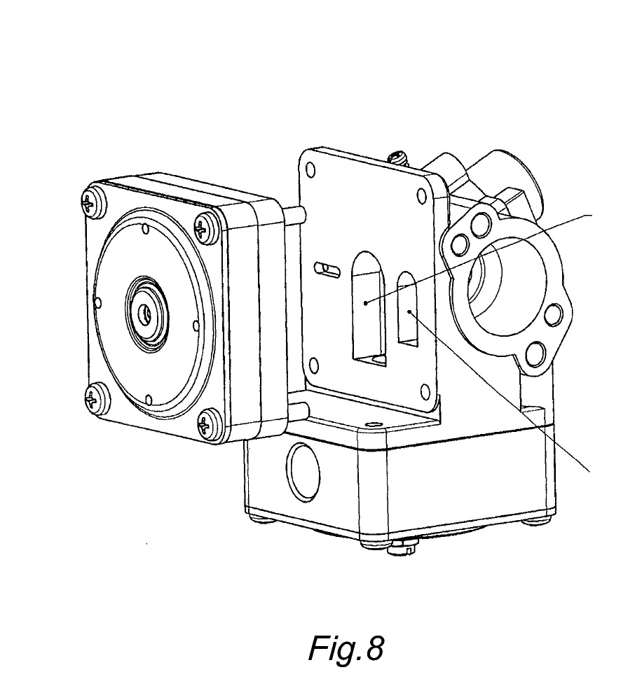

The second valve device 40, including all of its components (e.g. diaphragm 46, valve 50, bypass passage 51, etc) can be formed as a separate assembly that is connected all at once to the main body 2 enabling easy assembly of the mixing device, and different valve devices to be used with similar bodies to facilitate providing mixing devices for a wide range of engines and engine applications. The lid 47 and casing 44 may be held together by the same fasteners used to connect the second valve device 40 to the main body 2, by separate fasteners, any suitable connection feature or device, or a combination of any of the above, as desired. The first valve device 20 and its components may likewise be formed as a separate assembly and connected to the main body 2 in a similar manner, as generally shown in FIG. 8.

FIG. 6 shows the main body 2 further including a second conduit 13 formed in an end of the main body 2 whereby the second conduit 13 communicates with the second valve device inlet port 43 and can allow fuel to flow into the second valve device 40. A second groove passage 14 can be formed in the main body 2 as an open channel for communication with the second conduit 13. The second groove passage 14 and the second conduit 13 together form the second fuel passage 16 using the intermediate plate 62 as a part of the passage wall.

As can be appreciated in FIGS. 7 and 8, the first fuel passage 15 and the second fuel passage 16 may be formed directly in the body 2 when it is cast or otherwise formed, and the passages 15 and 16 may be substantially parallel to each other. This can help minimize the volume of the main body 2 and facilitate forming the passages 15 and 16. The upper end of each of the first and second fuel passages 15 and 16 may be defined by a section of reduced volume relative to other sections of the fuel passages 15 (e.g. as shown in FIG. 6 with regard to the second passage 16). As a result, the intake bore 4 can be expanded toward the two valve devices 20 and 40 by an amount commensurate to the space created by the volume reduction of the fuel passages 15 and 16, as best shown in FIGS. 3 and 6.

In operation, fuel from a fuel supply (such as a fuel tank) is introduced into the fuel injection port 41and passes through the first fuel passage 15 before it reaches the first valve 25 as best shown in FIG. 5. Hence, fuel from the fuel supply is communicated with the first valve 25 via the first fuel passage 15. When the section of the intake bore 4 downstream of the throttle valve 8 becomes negative in pressure, the first negative pressure chamber 31 also becomes subatmospheric or negative in pressure via the main body negative pressure induction passage 17 and negative pressure induction passage 32. The negative pressure may displace the first diaphragm 29 toward the outer plate 21. As a result, the rod 30 pushes the stem 26b and the first valve 25 opens. The part of the intake bore 4 downstream of the throttle valve 8 becomes negative in pressure when the engine connected to the fuel and air mixing device 1 is cranked or operating normally causing the first valve 25 to be opened generally when the engine is operating. The fuel that has passed through the first valve 25 flows from the first valve device 20 via the first valve device outlet port 23 and into the second fuel passage 16.

After passing through the second fuel passage 16, the fuel may then flow to the second valve device 40 via the second valve device inlet port 43 and reach the fuel pressure regulating valve 50. When the fuel pressure regulating chamber 45 becomes negative in pressure beyond a threshold level, the second diaphragm 46 moves toward the lever 53, and the central projection 48 of the second diaphragm 46 may then push the one end of the fuel pressure regulating lever 53. This action may cause the valve member 54 attached to the other end of the fuel pressure regulating lever 53 to move away from the second valve seat 55 and the pressure regulating valve 50 to open. Fuel then flows through the regulating valve 50 and to the intake bore 4 via the fuel ejection passage 9. The fuel pressure regulating valve 50 may be appropriately adjusted by the fuel pressure regulating mechanism 49 so that the fuel pressure regulating valve 50 opens at a threshold negative pressure level. In this manner, the pressure at which fuel exits the regulating valve 50 is controlled.

In an illustrated embodiment, a prescribed amount of fuel is constantly supplied to the intake bore 4 via the bypass passage 51 when the first valve 25 is open to support idle operation of the engine without running too lean, which otherwise may occur when negative pressure fails to open the fuel pressure regulating valve 50. The flow rate of fuel passing through the bypass passage 51 may be adjusted by the bypass flow rate control mechanism 58 which can be adjusted with a control knob. The fuel that has passed through the fuel pressure regulating valve 50 and bypass passage 51 can be regulated to a prescribed pressure in the fuel pressure regulating chamber 45 and then flow into the fuel ejection passage 9 via the second valve device outlet port 42. Fuel can be metered by the fuel ejection control mechanism 10 provided in the fuel ejection passage 9 so that a prescribed amount of fuel gas flows into the nozzle 6 and is ejected out of the nozzle 6 and mixed with air. The produced fuel and air mixture may then pass to the engine.

It should be recognized that the embodiments of the mixture device assembly discussed above are intended to be illustrative of some presently preferred embodiments of the invention, and not limiting. Various modifications within the spirit and scope of the invention will be readily apparent to those skilled in the art. The invention is defined by the claims that follow.

1. A fuel mixing device, comprising:
a body having an intake bore, a first surface, and a second surface adjacent to the first surface;
a first valve device carried by the body on the first surface and including a valve having open and closed positions and permitting fuel flow therethrough when the valve is open;
a second valve device carried by the body on the second surface and downstream of the first valve, the second valve device including a valve having open and closed positions and permitting fuel flow to the intake bore when the valve is open;
a first fuel passage provided in the body, communicating with the first valve device and adapted to communicate with a supply of fuel; and
a second fuel passage communicating with the second valve device and the first fuel passage to permit fuel that has passed through the first valve device to flow to the second valve device, wherein the first fuel passage and the second fuel passage connect to at least one of the first surface or the second surface.

2. The fuel mixing device of claim 1, wherein the first valve device further comprises an outer plate and an intermediate plate and the first valve device is formed as a separate assembly from the body that is attached to the body.

3. The fuel mixing device of claim 1, wherein the valve of the first valve device includes a valve seat and a valve head arranged to selectively engage the valve seat to prevent fuel flow between the first and second fuel passages, and a diaphragm actuated by a difference in pressure across opposed sides of the diaphragm and capable of moving the valve head from the valve seat to permit fuel flow to the second fuel passage.

4. The fuel mixing device of claim 3, wherein a pressure signal provided by operation of an engine with which the mixing device is used is communicated with the diaphragm to cause the diaphragm to move the valve head from the valve seat and in the absence of a pressure signal above a threshold magnitude, the valve head remains on the valve seat to prevent fuel flow to the second fuel passage.

5. The fuel mixing device of claim 1, wherein two operating characteristics of the second valve device are adjustable and two control mechanisms are located adjacent the exterior of the second valve device so that they are accessible from the same side of the body.

6. The fuel mixing device of claim 1, wherein the second valve device further comprises a fuel pressure regulating chamber separated from the first fuel passage by a partition wall.

7. The fuel mixing device of claim 6, wherein a spring is disposed at least in part in a recessed part of the partition wall facing away from the first fuel passage.

8. The fuel mixing device of claim 1, wherein the first valve device and the second valve device are positioned substantially perpendicular to each other.

9. The fuel mixing device of claim 3, wherein the second valve device is formed as a separate assembly from the body and includes a lid, a casing, a diaphragm carried between the lid and casing, and a valve actuated by movement of the diaphragm, the valve includes a valve head and a valve seat through which fuel flows from the second fuel passage to the intake bore when the valve head is moved from the valve seat.

10. The fuel mixing device of claim 1 wherein the first valve device is formed as a separate assembly from the body and includes an outer place, an intermediate plate, a diaphragm disposed adjacent to at least one of the outer or intermediate plates, and a valve actuated in response to movement of the diaphragm, the valve includes a valve head and a valve seat through which fuel flows from the first fuel passage to the second fuel passage when the valve head is moved from the valve seat.

11. The fuel mixing device of claim 10 wherein the first valve device is formed as a separate assembly from the body and includes an outer place, an intermediate plate, a diaphragm disposed adjacent to at least one of the outer or intermediate plates, and a valve actuated in response to movement of the diaphragm, the valve includes a valve head and a valve seat through which fuel flows from the first fuel passage to the second fuel passage when the valve head is moved from the valve seat.

12. The fuel mixing device of claim 1 wherein the second surface and the first surface are substantially parallel to an axial line of the intake bore.

13. The fuel mixing device of claim 5 wherein the second valve device further comprises a chamber downstream of the valve of the second valve device, a diaphragm, a spring acting on the diaphragm, a bypass passage through which fuel flows into the chamber even when the valve is closed, and a bypass flow rate control that can be adjusted to control the flow rate of fuel through the bypass passage, and wherein one of the two control mechanisms is associated with the spring to permit adjustment of the force of the spring on the diaphragm, and the other of the two control mechanisms is associated with and permits adjustment of the bypass flow rate control.

14. A fuel mixing device, comprising:
a body having an intake bore, a first surface, and a second surface;
a first valve device formed as a separate assembly from the body and mounted on the first surface, the first valve device including a valve and being constructed so that the valve is open when an engine associated with the mixing device is operating and closed when the engine is not operating;
a second valve device formed as a separate assembly from the body, and mounted on the second surface;
a first fuel passage formed within the body for carrying fuel between a fuel source and the first valve device;
a second fuel passage formed within the body for carrying fuel between the first valve device and the second valve device; and
at least one control mechanism that adjusts fuel flow into the intake bore, is carried by the body and is associated with at least one of the first valve device or the second valve device, wherein the first valve device permits fuel flow to the second valve device when the engine is operating and the second valve device is constructed to regulate the pressure of fuel delivered to the intake bore.

15. The fuel mixing device of claim 14, wherein the first valve device includes a valve seat and a valve head arranged to selectively engage the valve seat to prevent fuel flow between the first and second fuel passages, and a diaphragm actuated by a difference in pressure across opposed sides of the diaphragm and capable of moving the valve head from the valve seat to permit fuel flow to the second fuel passage.

16. The fuel mixing device of claim 15, wherein a pressure signal provided by operation of an engine with which the mixing device is used is communicated with the diaphragm to cause the diaphragm to move the valve head from the valve seat and in the absence of a pressure signal above a threshold magnitude, the valve head remains on the valve seat to prevent fuel flow to the second fuel passage.

17. The fuel mixing device of claim 14, wherein two operating characteristics of the second valve device are adjustable and two control mechanisms are located adjacent the exterior of the second valve device so that they are accessible from the same side of the body.

18. The fuel mixing device of claim 14, wherein the first valve device and the second valve device are positioned substantially perpendicular to each other.

19. The fuel mixing device of claim 14, wherein the second valve device is formed as a separate assembly from the body and includes a lid, a casing, a diaphragm carried between the lid and casing, and a valve actuated by movement of the diaphragm, the valve includes a valve head and a valve seat through which fuel flows from the second fuel passage to the intake bore when the valve head is moved from the valve seat.

20. The fuel mixing device of claim 14 wherein the first valve device is formed as a separate assembly from the body and includes an outer place, an intermediate plate, a diaphragm disposed adjacent to at least one of the outer or intermediate plates, and a valve actuated in response to movement of the diaphragm, the valve includes a valve head and a valve seat through which fuel flows from the first fuel passage to the second fuel passage when the valve head is moved from the valve seat.

21. The fuel mixing device of claim 14 wherein the second surface and the first surface are substantially parallel to an axial line of the intake bore.

22. The fuel mixing device of claim 17 wherein the second valve device further comprises a valve, a chamber downstream of the valve, a diaphragm, a spring acting on the diaphragm, a bypass passage through which fuel flows into the chamber even when the valve is closed, and a bypass flow rate control that can be adjusted to control the flow rate of fuel through the bypass passage, and wherein one of the two control mechanisms is associated with the spring to permit adjustment of the force of the spring on the diaphragm, and the other of the two control mechanisms is associated with and permits adjustment of the bypass flow rate control.
